(19) United States
(12) Patent Application Publication
(10) Pub. No.: US 2024/0258524 A1
(43) Pub. Date: Aug. 1, 2024

(54) ANODE ACTIVE MATERIAL FOR SODIUM SECONDARY BATTERY AND SODIUM SECONDARY BATTERY COMPRISING SAME

(71) Applicants: Korea University Research and Business Foundation, Seoul (KR); KOREA BASIC SCIENCE INSTITUTE, Daejeon (KR)

(72) Inventors: Young-Keun KIM, Seoul (KR); Yong-Mook KANG, Seoul (KR); Ji-Ung CHO, Uiwang-si (KR); Bum-Chul PARK, Seoul (KR); Dae-Bum LEE, Seoul (KR)

(73) Assignees: Korea University Research and Business Foundation, Seoul (KR); KOREA BASIC SCIENCE INSTITUTE, Daejeon (KR)

(21) Appl. No.: 18/408,128

(22) Filed: Jan. 9, 2024

(30) Foreign Application Priority Data
Jan. 26, 2023 (KR) 10-2023-0009952

(51) Int. Cl. H01M 4/60; H01M 4/36; H01M 4/52; H01M 10/054; H01M 4/02

(52) U.S. Cl. CPC H01M 4/60; H01M 4/366; H01M 4/523; H01M 10/054; H01M 2004/021; H01M 2004/027

(57) ABSTRACT

The present disclosure relates to an anode active material for a sodium secondary battery, which has a layered crystal structure and is formed of nanoplatelets containing iron oxide having organic anions, and in which the nanoplatelets are provided in plural numbers and formed in a stacking structure spaced apart at a first interval.

### CROSS-REFERENCE TO RELATED APPLICATION

This application claims priority from Korean Patent Application No. 10-2023-0009952 filed on Jan. 26, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to an anode active material for a sodium secondary battery and a sodium secondary battery including the same, and more specifically, to an anode active material for a sodium secondary battery, having improved charge/discharge efficiency, high capacity and high stability, and a sodium secondary battery including the same.

### Description of Related Art

While the development of new renewable energy and the reduction of carbon dioxide are essential, the development of secondary battery technology that can store power is essential in order to use the produced energy efficiently. Among these secondary batteries, lithium secondary batteries with high energy density and voltage, long cycle life, and low self-discharge rate have been commercialized and are widely used. However, since a lot of rare metals such as cobalt, nickel, and lithium are used in lithium secondary batteries, there is concern about the supply of these rare metals as demand for large-sized secondary batteries increases.

Accordingly, materials to replace lithium are being studied, and recently, the development of sodium secondary batteries with high oxidation-reduction potential and energy density is being actively conducted.

A sodium secondary battery consists of a cathode containing a cathode active material including sodium, an anode containing an anode active material capable of reversibly intercalating and deintercalating sodium ions, and an electrolyte, and as sodium ions are reciprocated between the anode and the cathode through the electrolyte so that charge/discharge of the battery occurs.

Meanwhile, sodium ions are larger than lithium ions, so their diffusion rate is slow and their reaction activity is also very low. Due to characteristics of such sodium ions, the materials that can be used in the anode of sodium secondary batteries are limited. Specifically, active materials that can be used in electrodes for sodium secondary batteries must have small primary particles and a high diffusion rate. In addition, when electrode materials normally used in lithium secondary batteries are applied to sodium secondary batteries, in most cases, capacity is not expressed compared to the characteristics shown in lithium secondary batteries, or there is rapid capacity degradation and property deterioration.

Accordingly, various studies are being conducted on anode active materials that efficiently maintain electrochemical properties in sodium secondary batteries.

Prior patent: Korea Patent No. 10-1470602 (2014 Dec. 2)

### SUMMARY

An object of the present disclosure is to provide an anode active material for a sodium secondary battery, which can control the rapid oxidation number change of iron ions occurring during the oxidation-reduction conversion reaction process and induce a stable chemical reaction by using a novel anode active material, and a sodium secondary battery including the same.

Further, another object of the present disclosure is to provide an anode active material for a sodium secondary battery, having a crystal structure in the form of an expanded lattice constant by combining iron hydroxide and acetate components in a layered structure, and a sodium secondary battery including the same.

According to one aspect of the present disclosure, embodiments of the present disclosure include an anode active material for a sodium secondary battery and a sodium secondary battery including the same.

In one embodiment, there is included an anode active material for a sodium secondary battery, which has a layered crystal structure and is formed of nanoplatelets containing iron oxide having organic anions, and in which the nanoplatelets are provided in plural numbers and formed in a stacking structure spaced apart at a first interval.

In one embodiment, the iron oxide may include FeOOH or Fe₃O₄, and the organic anions may include an acetate (CH₃COO—)-based compound.

In one embodiment, the organic anions may include an acetate group, and the acetate group may be connected to the iron oxide by bidentate bridging.

In one embodiment, the nanoplatelets may have a lepidocrocite-type structure.

In one embodiment, the nanoplatelets may be 1.8 to 2 times the lattice spacing of orthorhombic lepidocrocite.

In one embodiment, the layered crystal structure may have lattice constants of a=3.035±0.003 Å, b=22.86±0.02 Å, and c=3.8120±0.001 Å.

In one embodiment, the first spacing may be 1.14 nm to 1.29 nm as a spacing between (101) planes.

In one embodiment, FeOOH nanoparticles may be reversibly converted into Fe₃O₄ nanoparticles in the charge/discharge process, the FeOOH nanoparticles and Fe₃O₄ nanoparticles each have an average diameter of 10 nm or less, and the crystallinity of the Fe₃O₄ nanoparticles may be higher than that of the FeOOH nanoparticles.

In one embodiment, the nanoplatelets have a disk-shaped morphology, and the nanoplatelets may have a width of 27±5 nm and an axial thickness of 19±6 nm.

In one embodiment, the anode active material for a sodium secondary battery includes a repeatedly stacked nanoplatelet structure and may perform intercalation of sodium ions and a biotic-reaction-type conversion reaction.

In one embodiment, the anode active material may include an iron oxide having an acetate group, the iron oxide may be FeOOH nanoparticles or Fe₃O₄ nanoparticles, the anode active material may be reduced from FeOOH nanoparticles to Fe₃O₄ nanoparticles during charging, the acetate group may be oxidized, and bicarbonate may be formed by the oxidation of the acetate group so that it may act as a host for storing sodium ions.

In one embodiment, the acetate group may be oxidized to produce bicarbonate ions (HCO³⁻), and the bicarbonate ions may act as a host for storing sodium ions to produce any one or more of sodium hydrogen carbonate (NaHCO₃) and sodium carbonate (Na₂CO₃).

There is included a sodium secondary battery including: an anode containing the above-described anode active material for a sodium secondary battery; and a cathode containing sodium, wherein the anode contains Na₂CO₃ or Na₂O in the surface thereof, and Na₂CO₃ is provided in a larger amount than Na₂O.

In one embodiment, the anode active material may include iron oxide having an acetate group, the iron oxide may be FeOOH nanoparticles or Fe₃O₄ nanoparticles, the anode active material may be reduced from FeOOH nanoparticles to Fe₃O₄ nanoparticles during charging, the acetate group may be oxidized to produce bicarbonate ions (HCO³⁻), and the bicarbonate ions may act as a host for storing sodium ions to produce any one or more of sodium hydrogen carbonate (NaHCO₃) and sodium carbonate (Na₂CO₃).

According to the present disclosure as described above, an anode active material for a sodium secondary battery, which facilitates the deintercalation and intercalation of sodium atoms with a larger atomic radius than lithium by combining iron hydroxide and acetate components by a layered structure to further expand the interlayer gap, and a sodium secondary battery including the same can be provided.

In addition, according to the present disclosure, an anode active material for a sodium secondary battery having an iron hydroxide-acetate mixed hybrid electrode structure by simulating the oxidation-reduction reaction of biological iron (Fe) in a natural state, and a sodium secondary battery including the same can be provided.

### BRIEF DESCRIPTION OF DRAWINGS

FIG. 1 is a diagram showing the morphology of an anode active material for a sodium secondary battery according to an embodiment of the present disclosure.

FIG. 2 is a diagram schematically showing the conversion reaction of an anode active material for a sodium secondary battery according to an embodiment of the present disclosure.

FIG. 3 is views showing the characteristics of FAHP with expanded interlayer space.

FIG. 4 is views showing the morphology of an anode active material for a sodium secondary battery according to an embodiment of the present disclosure.

FIG. 5 is schematic diagrams showing the crystal structures of FAHP and lepidocrocite according to an embodiment of the present disclosure.

FIG. 6 shows results of surface analysis of FAHP according to an embodiment of the present disclosure.

FIG. 7 shows results of composition analysis using thermal image conversion of FAHP according to an embodiment of the present disclosure.

FIG. 8 shows results of confirming the electrochemical properties of FAHP according to an embodiment of the present disclosure.

FIG. 9 shows retention capacities per cycle at 100 mA g⁻¹ of FAHP and FeOOH according to an embodiment of the present disclosure.

FIG. 10 shows results of confirming the charge/discharge process conversion mechanism of FAHP according to this embodiment.

FIG. 11 shows results of 2D in situ XRD analysis of FAHP according to this embodiment.

FIG. 12 shows Mossbauer spectra of FAHP according to this embodiment.

FIG. 13 shows phase conversions of FAHP according to the conversion reaction.

FIG. 14 shows results of confirming microstructural changes that occur in the charge/discharge process of FAHP according to this embodiment.

FIG. 15 shows results of elemental analysis performed in the FAHP conversion reaction.

FIG. 16 shows results of analyzing the surface reaction of the FAHP anode in an embodiment of the present disclosure.

FIG. 17 is conversion reaction graphs obtained from Fe2p XP.

FIG. 18 shows results of surface analysis of an anode active material for a sodium secondary battery according to an embodiment of the present disclosure.

FIG. 19 shows FT-IR spectra of an anode active material for a sodium secondary battery according to an embodiment of the present disclosure.

FIG. 20 shows results of analyzing the conversion reaction of an anode active material for a sodium secondary battery according to an embodiment of the present disclosure at 20 cycles and 50 cycles.

FIG. 21 shows results of analyzing the surface reaction of lepidocrocite.

FIG. 22 shows results of analyzing the surface reaction of FAHP and lepidocrocite according to an embodiment of the present disclosure.

### DETAILED DESCRIPTIONS

Specific details of other embodiments are included in the detailed description and drawings.

The advantages and features of the present disclosure and methods for achieving them will become clear by referring to the embodiments described in detail below along with the accompanying drawings. However, the present disclosure is not limited to the embodiments disclosed below, but may be implemented in various different forms, and unless otherwise specified in the description below, all numbers, values and/or expressions expressing the components, reaction conditions, and contents of the components in the present disclosure should be understood as being modified by the term “about” in all cases since such numbers are inherently approximations reflecting the various uncertainties of measurement that arise in obtaining such values among other things. Additionally, where numerical ranges are disclosed in this description, such ranges are continuous and, unless otherwise indicated, include all values from the minimum value of such a range to the maximum value including a maximum value. Furthermore, if such a range refers to an integer, it includes all integers from the minimum value up to the maximum value including a maximum value, unless otherwise indicated

Additionally, when a range is described in the present disclosure for a variable, the variable will be understood to include all values within the described range, including the described end points of the range. For example, the range “5 to 10” not only includes the values 5, 6, 7, 8, 9, and 10, but also includes any subranges such as 6 to 10, 7 to 10, 6 to 9, 7 to 9, etc., it will be understood that it also includes any values between integers that valid for the category of the described range, such as 5.5, 6.5, 7.5, 5.5 to 8.5, and 6.5 to 9, etc. For example, the range “10% to 30%” not only includes all integers including the values of 10%, 11%, 12%, 13%, etc., and all integers including up to 30%, but also includes any subranges such as 10% to 15%, 12% to 18, and 20% to 30%, etc., and it is also understood to include any values between valid integers within the category of the described range, such as 10.5%, 15.5%, 25.5%, etc.

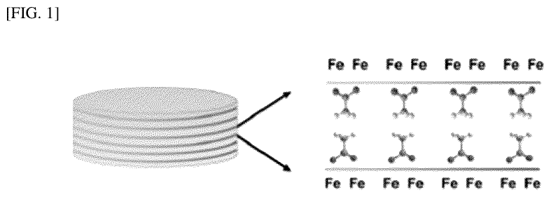

FIG. 1 is a diagram showing the morphology of an anode active material for a sodium secondary battery according to an embodiment of the present disclosure. This is a diagram schematically showing the anode active material according to this embodiment, which is stacked layer by layer in the form of nanoplatelets.

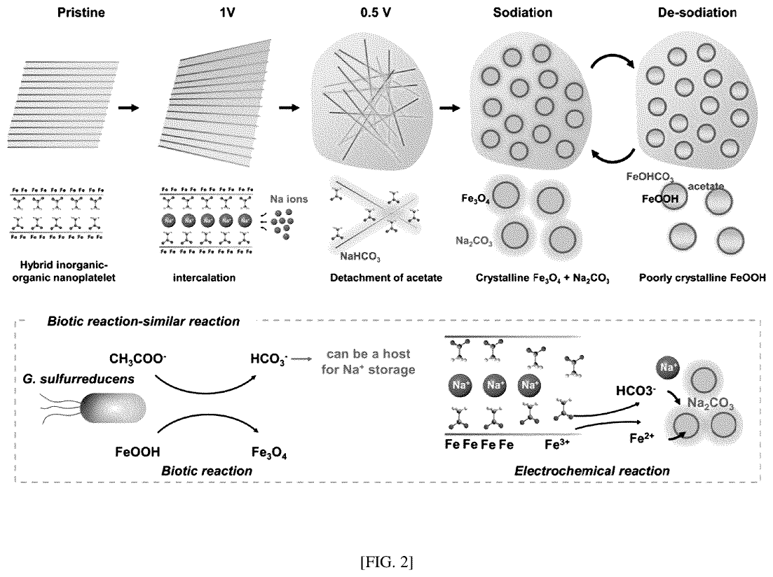

FIG. 2 is a diagram schematically showing the conversion reaction of an anode active material for a sodium secondary battery according to an embodiment of the present disclosure.

Referring to FIGS. 1 and 2, the anode active material for a sodium secondary battery according to this embodiment has a layered structure and may be formed of a nanoplatelet containing iron oxide having organic anions. Additionally, the nanoplatelet may be provided in plural numbers and formed in a stacking structure spaced apart at a first interval.

In the anode active material for a sodium secondary battery, the iron oxide may include FeOOH or Fe₃O₄, and the organic anions may include an acetate (CH₃COO—)-based compound. For example, the acetate-based compound may include at least one of sodium acetate, potassium acetate, and ammonium acetate.

The organic anions can be coordinated with the iron oxide to expand the first interval between the nanoplatelets, thereby facilitating the intercalation and deintercalation of sodium ions (0.3 Å), which are larger than lithium ions. Therefore, in a sodium secondary battery employing the anode active material for a sodium secondary battery, the poor electrochemical properties and cycle characteristics that were problematic due to the large size of conventional sodium ions can be improved. In addition, a cathode active material for a sodium secondary battery according to this embodiment has high structural stability so that the structure can be maintained without collapse even during the process of performing the charge and discharge cycle.

The organic anions may be provided in coordination with the iron oxide, and while the first interval is maintained in an expanded state by the organic anions, structural stability can be improved. Additionally, the organic anions can be oxidized and act as a host for sodium ions during the process of performing a charge/discharge cycle on the anode active material for a sodium secondary battery.

The anode active material for a sodium secondary battery according to this embodiment can improve the electrochemical properties of a sodium secondary battery by oxidation of the organic anions along with highly reversible oxidation and reduction conversion of iron oxide.

Specifically, the organic anions include an acetate group, and the acetate group may be connected to the iron oxide by bidentate bridging.

The nanoplatelets may have a zigzag structure due to edge sharing of the octahedral structures of adjacent iron oxides and corner sharing by organic anions.

Specifically, the a-axis direction is similar to other FeOOHs with existing layered crystal structures due to edge sharing of Fe atoms in the octahedron of iron oxide, but in the c-axis direction, distortion is occurred by the organic anions so that the edge sharing is broken, Fe atoms are attached due to corner sharing, and it can have a layered crystal structure different from the existing layered crystal structure of FeOOH, in which nanoplatelets are stacked with wide layer spacing in the b-axis direction in a distorted state.

Specifically, the layered crystal structure may have lattice constants of a=3.035±0.003 Å, b=22.86±0.02 Å, and c=3.8120±0.001 Å.

The nanoplatelets may have a lepidocrocite-type structure. Specifically, the nanoplatelets may be 1.8 to 2 times the lattice spacing of orthorhombic lepidocrocite. There are problems in that if the lattice spacing is less than 1.8 times, the size is too small and it is not easy to intercalate sodium ions, and if it is more than 2 times, structural stability is reduced.

Specifically, the anode active material for a sodium secondary battery according to this embodiment may include iron oxide having a layered crystal structure. Specifically, the iron oxide may be iron oxide or iron hydroxide. For example, when the iron oxide is FeOOH, it may induce intercalation of acetate in the process of crystallization of FeOOH, and may be provided as FeOOH-acetate hybrid nanoplatelets (FAHP), an anode active material for a sodium secondary battery in which the lepidocrocite is formed to be 1.5 to 2.5 times, or 2 to 2.5 times in the b-axis direction.

The nanoplatelets may be provided by stacking a plurality thereof, and neighboring nanoplatelets may be provided spaced apart from each other at a first interval. The first spacing is a spacing between (101) planes and may be 1.14 nm to 1.29 nm. The first interval is provided within the above-mentioned range, and thus the electrochemical properties of the sodium secondary battery can be improved by stably acting as a host for sodium ions.

The nanoplatelets may be provided to have a disk-shaped morphology, a width of 27±5 nm, and an axial thickness of 19±6 nm.

The anode active material for a sodium secondary battery according to this embodiment may have a conversion mechanism in the following manner. Sequentially, (1) the intercalation of sodium ions is promoted by the interlayer interval of the anode active material for a sodium secondary battery at 1V, and (2) the acetate moiety may be separated from the surface of FeOOH nanoplatelet, a type of iron oxide. Subsequently, NaHCO₃ is formed at 0.75 and 0.5 V, and (3) FeOOH, iron oxide, may be converted into Fe₃O₄ nanoparticles (size<10 nm) while being encapsulated by Na2CO3 in a completely discharged state. (4) In the fully charged state, crystalline Fe₃O₄ nanoparticles may be converted into low-crystalline FeOOH nanoparticles (size<10 nm), and decomposition of Na₂CO₃ may occur. In this conversion mechanism, (3) and (4) may be performed repeatedly throughout the cycle of the sodium secondary battery.

The anode active material for a sodium secondary battery according to this embodiment is completely different from the conventional one. Specifically, most conversion reactions in the existing FeOOH system were described as only iron oxide redox reactions, but the system according to this embodiment is derived from the redox coupling reaction between FeOOH and acetate and includes two simultaneous conversion reactions. Specifically, it is shown as (i) conversion between crystalline Fe₃O₄ and low-crystalline FeOOH and (ii) formation-decomposition of Na₂CO₃.

Upon initial discharge of up to about 1 V versus Na/Na⁺, sodium ions are intercalated into the interlayer space of the nanoplatelets. The anode active material for a sodium secondary battery according to this embodiment may have a d-spacing, which is a first interval, that is more expanded than that of a conventional anode system showing a small lattice parameter, thereby facilitating intercalation of sodium ions.

Additionally, the acetate moiety coordinated with Fe of the iron oxide is deintercalated from the surface when the voltage becomes less than 1 V at 1 V versus Na/Na⁺. The deintercalated acetate moiety can react directly with H₂O to produce HCO³⁻, which reacts with Na⁺ to form NaHCO₃ and is further converted to Na₂CO₃. H₂O required for HCO³⁻ formation can be provided by a dehydration process during the conversion from FeOOH to Fe₃O₄. Since the formation of Na₂CO₃ occurs simultaneously with the phase conversion from FeOOH to Fe₃O₄ on the FeOOH surface, Na₂CO₃ forms a stable interface with Fe while encapsulating nanocrystalline Fe₃O₄ (size<10 nm).

The irreversible reactions in the initial discharge process appear very similar to microbially mediated biological Fe redox reactions, known as the biogeochemical Fe cycle. Geobacter sulfurreducens, one of the most widely known bacteria in the biogeochemical Fe cycle, forms bicarbonate formed by oxidation of acetate through reduction of FeOOH to Fe₃O₄. The bicarbonate and carbonate moieties formed by the reductive coupling reaction of Fe and acetate functional groups act as hosts for Na⁺ storage. The nanoplatelet structure, in which FeOOH and acetate are repeatedly laid up layer by layer, enables uniform Na⁺ intercalation and biotic-reaction-type conversion reaction to improve reversible cycle characteristics.

The morphology of Na₂CO₃ nanoparticles embedded in the Na₂CO₃ matrix allows the conversion reaction to proceed stably during the process of repeatedly performing the charge/discharge cycle. The initial charging process includes the oxidation reaction of Fe₃O₄ to FeOOH and the decomposition of Na₂CO₃. Carbonate decomposed from Na₂CO₃ exists as bicarbonate and acetate moieties that bind to the surface of FeOOH, and accordingly Na₂CO₃ may be produced in the subsequent discharge cycle.

Specifically, in the anode active material for a sodium secondary battery, FeOOH nanoparticles are reversibly converted into Fe₃O₄ nanoparticles in the charge/discharge process, and the FeOOH nanoparticles and Fe₃O₄ nanoparticles may each have an average diameter of 10 nm or less. Additionally, the Fe₃O₄ nanoparticles may be provided with a crystallinity higher than that of the FeOOH nanoparticles.

The anode active material for a sodium secondary battery may include a repeatedly stacked nanoplatelet structure and perform intercalation of sodium ions and a biotic-reaction-type conversion reaction.

For example, the anode active material may include iron oxide having an acetate group, the iron oxide may be FeOOH nanoparticles or Fe₃O₄ nanoparticles, the anode active material may be reduced from FeOOH nanoparticles to Fe₃O₄ nanoparticles during charging, and the acetate group may be oxidized. Bicarbonate is formed by oxidation of the acetate group so that it may act as a host for storing sodium ions.

Specifically, when the acetate group is oxidized, bicarbonate ions (HCO³⁻) may be produced, and the bicarbonate ions may act as a host for storing sodium ions to produce any one or more of sodium hydrogen carbonate (NaHCO₃) and sodium carbonate (Na₂CO₃).

The sodium secondary battery showed excellent reversible capacity of 567 mA hg⁻¹ at 50 mA g⁻¹, and excellent retention capacity of 266 mA hg⁻¹ after 100 cycles were proceeded at a current density of 100 mA g⁻¹. In addition, also in the electrolyte solution, an electrolyte solution for existing sodium secondary batteries can be used as it is, for example, a 1M NaClO₄ solution of ethylene carbonate/diethyl carbonate (EC/DEC, 1:1 vol %) can be used as the electrolyte solution. The anode active material for a sodium secondary battery according to this embodiment can exhibit improved electrochemical performance compared to the case where a conventional carbon compound or FeOOH is used as the anode.

According to another aspect of the present disclosure, the present disclosure includes a sodium secondary battery including: an anode containing the above-described anode active material for a sodium secondary battery; and a cathode containing sodium, wherein the anode contains Na₂CO₃ or Na₂O in the surface thereof, and Na₂CO₃ is provided in a larger amount than Na₂O.

The anode active material may include iron oxide having an acetate group, the iron oxide may be FeOOH nanoparticles or Fe₃O₄ nanoparticles, and the anode active material may be reduced from FeOOH nanoparticles to Fe₃O₄ nanoparticles during charging. In addition, the acetate group is oxidized to produce bicarbonate ions (HCO³⁻), and the bicarbonate ions may act as a host for storing sodium ions to produce any one or more of sodium hydrogen carbonate (NaHCO₃) and sodium carbonate (Na₂CO₃).

Hereinafter, Example and Comparative Example of the present disclosure will be described. However, the following Examples are only Preferred Examples of the present disclosure and the scope of rights of the present disclosure is not limited by the following Examples.

### 1. FAHP (FeOOH-Acetate Hybrid Nanoplatelet) Synthesis

A modified polyol method for FAHP synthesis using Iron(III) chloride hexahydrate (FeCl₃·6H₂O) as the Fe³⁺ precursor and sodium acetate (NaOAc) and deionized water (Millipore Direct-Q UV 3) as the hydroxyl ion source was used.

3 mmol of FeCl₃·6H₂O was dissolved in 7.2 mL of deionized water, and subsequently while performing mild sonication for 15 min, 15 mmol of NaOAc was dissolved in 50 mL of ethylene glycol. Here, ethylene glycol acts as a reducing agent and solvent in the modified polyol method. Fe and an NaOAc solution were mechanical stirred at 25° C. for 15 min to be mixed, and then refluxed at 200° C. for 8 hr. During the reflux process, the yellow-brown, cloudy solution gradually changed to red-brown. After it was naturally cooled at 25° C., the red-brown precipitate was washed 5 times or more with water and ethanol to remove by-products. The washed sample was dried in a vacuum oven at 40° C. overnight, ground using a mortar and pestle so that it became a fine powder, and then stored in a nitrogen atmosphere.

### 2. Method for Evaluating Characteristics of FAHP

To confirm the morphology and structure of FAHP, TEM evaluation was performed using a double Cs monochromated TEM system (FEI, TITAN) operating at 300 kV or 80 kV, and bright-field, SAED, and STEM images were secured.

In FAHP, the FeOOH and acetate moieties, which are vulnerable to electron beam, were checked at low magnification in order to prevent decomposition. TEM samples were prepared by placing 7 μL of an ethanol solution containing FAHP at a concentration of 0.05 mg/mL on the grid. In the TEM and SEM images, the size of FAHP was averaged so that the average n>50. SEM evaluation was performed using a field emission SEM system (SU-70, Hitachi) operating at an acceleration voltage of 15.0 kV. Before performing SEM evaluation, the dried FAHP powder was sputter coated with platinum at 10 A for 60 seconds. The XP spectra of FAHP were recorded with a K-alpha plus spectrometer (Thermo Scientific, USA) using a monochromatic Al Kα (1486.6 eV) source. A narrow range scan was performed for Fe2p, O1s, C1s, and O2p at a pass energy of 50 eV. After excluding the Shirley-type background, the photoelectron emission line was fitted using the Gaussian-Lorentzian function. To characterize the crystal structure of FAHP, HRXRPD analysis was performed with the 9B-HRXRPD beamline at Pohang Accelerator Research Institute (Pohang, Korea). The X-ray incident line was vertically collimated using a mirror, and monochromated at a wavelength of 1.5216 Å using a double crystal Si(111) monochromator. The data set was collected over a range of 5°≤2θ≤146.5 with a 2θ step of 0.01°. The HRXRPD pattern of FAHP was fitted and indexed according to a doubly expanded lepidocrocite lattice along the b-axis using the Pawley method. Minor residual peaks were fitted by goethite.

The Pawley refinement method was performed using the TOPAS program and pseudo-Voigt profile-fitting function. To confirm the thermal image changes in FAHP, in situ thermal XRPD (PANalytical, X'Pert Pro MPD-HTK1200N hot stage) analysis having a Cu Kα radiation source (λ=1.5418 Å) was performed. TGA analysis was performed using an SDT Q 600 thermogravimetric analyzer (TA instruments), and the FAHP compositions were confirmed. The vacuum-dried samples were heated from room temperature to 800° C. at a ramp rate of 10° C. min⁻¹ under air flow. The compositions were confirmed by calculating the weight changes using in situ thermal XRPD and TGA.

### 3. Method for Evaluating Electrochemical Properties

For the FAHP electrode, a slurry was prepared by mixing FAHP, Super P, and polyacrylic acid (PAA) at a ratio of 70:20:10 using N-methyl pyrrolidinone (NMP) as a solvent. The prepared slurry was cast on a Cu foil and dried in a vacuum oven at 120° C. for 5 hours. In order to use a copper foil coated with an active material as an electrode, a hole was formed using a disk with a diameter of 12 mm. A CR2032 coin cell was assembled using a sodium foil and electrodes fabricated in an argon-filled glove box. Glass fiber (GF/D, Whatman) was used as a separator for the coin cell, and EC/DEC (1:1, v/v) and 1M NaPF₆ were used as an electrolyte. All electrochemical test results were measured in a voltage window of 0.005 to 3.0 V (versus Na/Na⁺) using the WonATech system. EIS data were measured using an IVIUMSTAT impedance analyzer with an amplitude of 5 mA in the frequency range of 10⁻² to 10⁵ Hz at room temperature.

### 4. In Situ XRPD Evaluation Method

To measure in situ XRPD analysis, a pouch-type battery cell was assembled using Li metal as the cathode, and a PANalytical X'Pert Pro diffractometer using a Cu-Kα source was used at room temperature. The FeOOH slurry was cast onto an Al foil and dried overnight in a vacuum chamber. The mass-loading per area of the FeOOH electrode is ˜4.15 mg cm⁻². The electrochemical cycle was performed at a current density of 20 mA g⁻¹ and a potential of 0.05 to 3.0 V. In the cycle process, single X-ray diffraction (XRD) patterns were recorded continuously for 30 minutes using a PIXcel 1D detector (PANalytical). The 2D images of the XRD patterns were created using Highscore Plus software (PANalytical).

### 5. Ex Situ Conversion Reaction Analysis

To analyze TEM, EELS, XPS, FT-IR, and Mossbauer, for the ex situ samples, various steps of the charge/discharge cycle were performed with cutoff voltage or current values set during constant current cycling tests at 20 mA g⁻¹. After maintaining sufficient rest period after cycling, the coin cells were opened in a glove box using a hydraulic disassembling press and stored in dimethyl carbonate (DMC) for further analysis. To obtain bright-field TEM/HRTEM/SAED images, a JEM-F200 electron microscope (JEOL Ltd.) equipped with a thermal field emission gun operating at 200 kV was used. HAADF-STEM/EDX/EELS results were obtained using a Cs-corrected STEM system equipped with a low-temperature field emission gun and a 965 GIF Quantum ER EELS detector operating at 200 kV. EEL spectra between 630 and 830 eV were acquired at 200 kV using a 1 nm probe at an acquisition time of 2 seconds. While all spectra were stored in dual-EELS mode, they were simultaneously corrected for zero-loss peaks. At a point with a diameter of 400 μm for charge compensation using two flood guns (supplying low-energy electrons and Ar ions) at the Korea Basic Science Institute (KBSI) Busan Center, XPS was performed by a K-ALPHA⁺XPS system (Thermo Fisher Scientific Inc., UK) using a monochromatic Al Kα X-ray source (hv=1,486.6 eV, acceleration voltage=12 kV, power=72 W). Avantage software provided by the manufacturer was used for spectrometer control and spectrum analysis. During the measurements, the base pressure of the turbopump analysis chamber was maintained at 1×10⁻⁹ mbar (UHV). Irradiation spectra were recorded at a pass energy of 300 eV and a resolution of 1 eV, and high-resolution spectra were obtained at a pass energy of 50 eV and a resolution of 0.1 eV. All obtained binding energies (BE) were compensated for by the adventitious carbon (C1s) core level peak at 284.6 eV. FT-IR spectra were recorded in the wavelength range of 4000 to 600 cm⁻¹ using a Thermo-Fisher iS10 spectrometer. ATR mode was used to characterize the samples. Mossbauer spectra were recorded with a constant acceleration transducer using a ⁵⁷Co in Rh matrix source with an initial activity of 50 mCi. Velocity calibration for each channel was performed using ⁵⁷Fe foil. The Mossbauer spectra of the samples were fit with respect to a doublet.

### 6. Evaluation of Characteristics of Expanded Lepidocrocite-Type Inorganic-Organic Hybrid Nanoplatelets

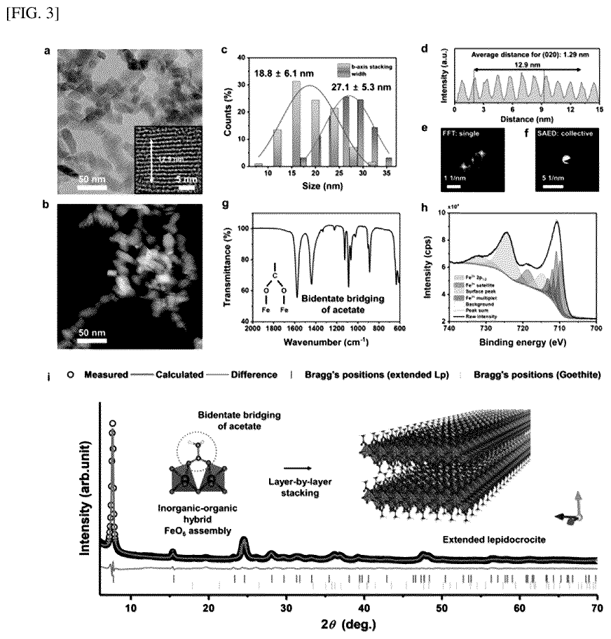

FIG. 3 is views showing the characteristics of FAHP with expanded interlayer space. In FIG. 3, FIG. 3A is a TEM image of FAHP, and FIG. 3B is a STEM images thereof. The insertion image is an enlarged view of the layered structure obtained through bright-field TEM. The inserted white arrow was shown as a trajectory in the line profile depicted in FIG. 3C. FIG. 3C is Gaussian distribution (n=100) of the width and b-axis size of FAHP measured in the TEM image. Measurement of the (020) interlayer distance obtained from the inserted image in FIG. 3A showed a basal spacing of 1.29 nm. FIG. 3D is a FFT pattern, FIG. 3E is a single FAHP, and FIG. 3F is a SAED pattern obtained from multiple FAHP. FIG. 3G is a FT-IR spectrum of FAHP, and showed interlayer insertion of acetate through bidentate bridging. In FIG. 3H, the binding energy decreased in that order of a deconvoluted Fe2p XP (blue), Fe³⁺ surface (sky blue), and Fe⁺ satellite (green) with peaks designated as Fe⁺ multiplets. FIG. 3I is a FAHP's synchrotron HRXRPD pattern. The inserted diagrams show a hypothesis of the atomic disposition of FAHP with a b parameter twice that of lepidocrocite.

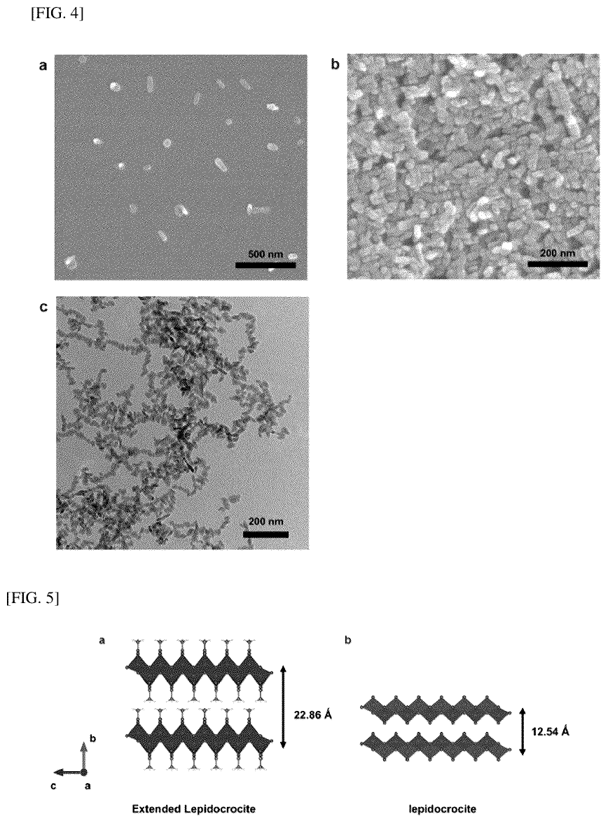

FIG. 4 is views showing the morphology of an anode active material for a sodium secondary battery according to an embodiment of the present disclosure. In FIG. 4, FIG. 4A is a SEM image confirmed at low magnification, and FIG. 4B is a SEM image confirmed at a high magnification. FIG. 4C is a TEM image confirmed at low magnification. The anode active material for a sodium secondary battery according to this embodiment may be provided in the form of sheets of nanoplatelets stacked in the [010] direction.

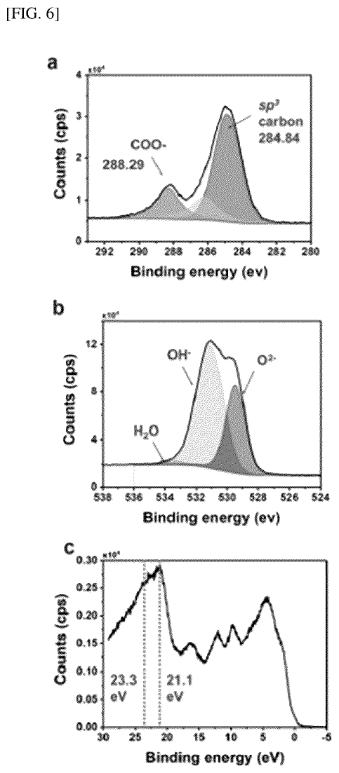

FIG. 5 is schematic diagrams showing the crystal structures of FAHP and lepidocrocite according to an embodiment of the present disclosure.

FIG. 6 shows results of surface analysis of FAHP according to an embodiment of the present disclosure.

In FIG. 6, FIG. 6A is deconvoluted O Cs XP spectra, and indicated as COO— (green), CO—Fe (sky blue), and sp³ C (blue) in order of increasing binding energy (BE). FIG. 6B is deconvoluted O 1s XP spectra, and indicated as H₂O (green), OH— (sky blue), and O₂₋ (blue) in order of increasing binding energy. FIG. 6C is O 2p and valence XP spectra. O 2p at peaks within each range were indicated as 23.3 and 21.1 eV.

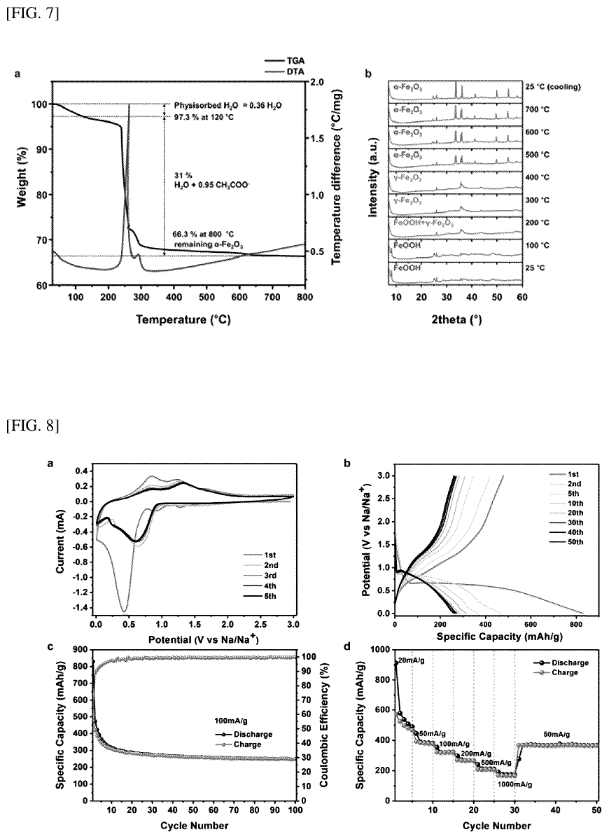

FIG. 7 shows results of composition analysis using thermal image conversion of FAHP. FIG. 7A is FAHP thermogravimetric and differential thermal analysis results. The dotted line indicates the elements decomposed in the corresponding temperature range. FIG. 7B is Thermal XRD patterns of FAHP checked during air flow. The XRD patterns were checked at intervals of 100° C. during heating to 700° C. and after cooling to room temperature. The phases of iron oxide produced at respective temperatures were confirmed as FeOOH·0.5CH₃COO (25 and 100° C.)→γ-Fe₂O₃ (200, 300, and 400° C.)→α-Fe₂O₃ (500, 600, and 700° C.).

The anode active material for a sodium secondary battery according to this embodiment may include FAHP, wherein FAHP was prepared using a modified polyol method and was prepared to have a hybrid inorganic-organic structure with a basal spacing of 1.29 nm. FAHP with a wide basal spacing was confirmed through low-magnification transmission electron microscopy (TEM) and high-angle annular dark-field scanning transmission electron microscopy (HAADF-STEM). FAHP could be confirmed to have a disk-shaped morphology, uniform width, axial thicknesses of 27±5 and 19±6 nm, and average of 14 to 15 layers (FIG. 4). Due to the line profile obtained for the single FAHP, and Fast Fourier-Transform (FFT), it could be confirmed that there was a uniform interval of 1.29 nm between the stacked 2D sheets. In addition, according to selected area electron diffraction (SAED) obtained for numerous FAHPs, a strong ring pattern was confirmed at d=1.29 nm, and it can be confirmed therefrom that 2D sheets were formed in a layered crystal structure in which the sheets were spaced apart and stacked at even intervals.

Synchrotron high-resolution X-ray powder diffraction (HRXRPD) analysis was performed on FAHP. A strong (0k0) reflection and a relatively less strong reflection at higher angles were confirmed, which are characteristics of a layered crystal structure with high orientation and low symmetry (FIG. 3I). The diffraction pattern of FAHP did not exactly correspond to the representative FeOOH phase which includes lepidocrocite and green rust ([Fe(ii)₁₋ₓFe(iii)ₓ(OH)₂]^{x+} or [(x/n)Aⁿ⁻·mH₂O]^{x-}) and has a layered crystal structure.

The indexed Bragg position for FAHP may be explained by twice the lattice spacing b parameter of orthorhombic lepidocrocite, although there is a small amount of minor phase presumed to be gothite (α-FeOOH). The suitability of the Pawley method was confirmed with an R_{wp} of 6.57% calculated using the TOPAS program. The HRXRPD data of lepidocrocite with an expanded b axis based on Pawley refinement may be indexed into an orthorhombic lattice of a=3.035(3) Å, b=22.86(2) Å, and c=3.8120(10) Å. Such results at d(₀₂₀)of 1.14 nm were shown similarly to the basal spacing of FAHP observed through TEM.

The extended interlayer stacking of FAHP was due to the intercalation of acetate moieties coordinated on the surface of 2D FeOOH sheets, and caused a topotactic transition from lepidocrocite to FAHP (FIG. 5). The FT-IR (Fourier transform infrared) spectra of FAHP showed no C═O peak at 1,716 cm⁻¹, and the average shift of Δ(νₐₛ(COFe)−νₛ(COOOFe)) for acetate coordination appeared to be 145 cm⁻¹, which was smaller than that of deprotonated acetate (FIG. 1G). Therefore, acetate coordination of Fe could be confirmed by bidentate bridging.

The presence of broad, low intensity diffraction peaks at high angles in the HRXRPD pattern complicated the determination of the location of the acetate moiety coordinated with Fe. Since the arrangement of the FeO₆ octahedron determines the crystal structure of FeOOH, acetate coordination was considered while maintaining the ac-plane arrangement of lepidocrocite. Therefore, considering the distance between adjacent oxygen atoms to which the acetate group is bonded in the crystal structure of lepidocrocite, it could be confirmed that coordination by bidentate bridging of acetate is formed in the direction parallel to the a-axis, and it was stacked and expanded in the b-axial direction (FIGS. 3I and 5).

The X-ray photoelectron spectroscopy (XPS) results of Fe2p and O1s closely corresponded to the typical profile of the FeOOH polymorph. The peaks due to the Fe³⁺ multiplets (four blown peaks) appearing in the Fe2p XPS profile indicate that Fe in FAHP exists in the Fe³⁺ state (FIG. 3H). The O1s XPS profile showed a surface oxygen (Fe—OH) content 1.85 times higher than that of lattice oxygen (Fe—O) (FIG. 6). The sp³, CO, and COO peaks which are 284.8, 286.2, and 288.3 eV, respectively, in the C1s XPS profiles are allocated to acetate molecules. The composition of the nanoplatelets was estimated to be Fe₂O₃·H₂O·0.95CH₃COO⁻ in TGA (thermogravimetric analysis) and in situ thermal X-ray powder diffraction (XRPD), which may also be expressed by FeOOH·0.48CH₃COO⁻ (FIG. 7). During the sequential thermal phase change of FAHP into maghemite (γ-Fe₂O₃) and hematite (α-Fe₂O₃), the proportion of H₂O produced by heating dehydration of FAHP at a temperature exceeding 120° C. under atmospheric conditions was calculated.

### 7. Sodium Storage Properties of FAHP

FIG. 8 shows results of confirming the electrochemical properties of FAHP. In FIG. 8, FIG. 8A is a CV profile measured at 0.1 mV s−1, FIG. 8B is a constant current charge/discharge profile measured at a current density of 100 mA g⁻¹, FIG. 8C is cycle characteristics at a current density of 100 mA g⁻¹, and FIG. 8D is cycle characteristics measured at various current densities (20 to 1,000 mA g⁻¹).

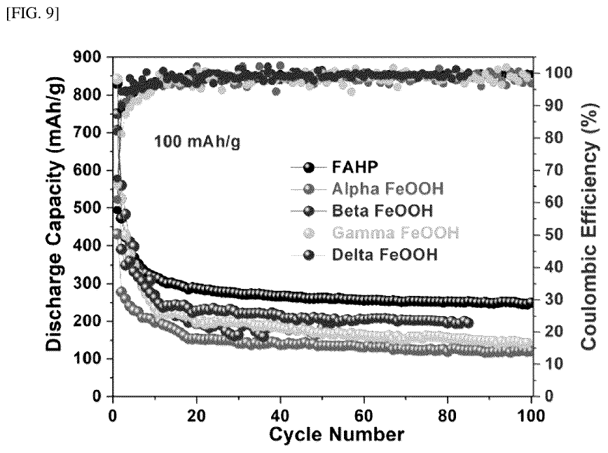

FIG. 9 shows retention capacities per cycle at 100 mA g⁻¹ of FAHP and FeOOH.

The sodium storage behavior of FAHP was confirmed through a half cell adopting Na metal as the counter electrode. FIG. 8A shows a cyclic voltammetry (CV) profile of FAHP in the voltage window of 0.005 to 3 V. In the initial anodic process, two strong peaks appeared at 1.28 and 0.92 V, and subsequently much broader peaks appeared at higher voltages. In the initial cathodic process, one strong peak dominated at 0.43 V, and two smaller peaks were present together at higher voltages.

As described above, the CV profile of the half-cell of FAHP according to this embodiment appeared different from the CV profiles of other FeOOH polymorphs used as anodes in SIB, whereas it appeared very similar to that of the β-FeOOH anode in LIB. In other words, it could be confirmed that the reaction path between Na and FAHP according to this embodiment was similar to the path between Li and FeOOH, not the reaction path between Na and FeOOH.

The initial lithiation of FeOOH occurs as Li intercalates into FeOOH. On the other hand, as observed in the graphite anode, Na⁺ has a large size so that it is not easy to insert it from SIB into the FeOOH anode. Therefore, interlayer insertion of Na mainly occurred on the surface rather than in the bulk, and FeOOH was partially reduced from Fe³⁺ to Fe⁰, showing a much lower reversible capacity than the conversion reaction with Li.

Compared to other FeOOH polymorphs, the interlayer spacing of FAHP according to this embodiment has been expanded due to the acetate group, and accordingly the bulk insertion of Na can be improved. On the other hand, due to the difference in redox reactions between Li and Na, it could be confirmed that the reaction between the FAHP anode and Na did not follow the reaction path between the FeOOH anode and Li.

Specifically, it could be confirmed that between β-FeOOH and Li, the oxidation peak following the first cycle was significantly shifted, and reduction peaks of low intensity appeared at high voltage. That is, it could be confirmed that FAHP according to this embodiment shows a low capacity in LIB so that it shows a higher reversible capacity in FAHP than in FeOOH in SIB during the bulk insertion process of Na.

Unlike the two peaks corresponding to the oxidation of Fe⁰ to Fe²⁺ and the oxidation of Fe²⁺ to Fe³⁺ in Fe₂O₃, at least four reduction peaks were confirmed in the CV profiles of the β-FeOOH anodes of LIB and SIB. The reaction mechanism of FeOOH is more complex than that of other substances, and therefore it is not easy to designate the reduction peak of FeOOH. According to the galvanostatic discharge/charge profiles at a current density of 100 mA g⁻¹ (FIG. 8B), FAHP exhibits a reversible capacity of 479 mA hg⁻¹. It could be confirmed that the efficiency increased and decreased in the process of increasing the cycle with a Coulombic efficiency of up to 58% in the first cycle, up to 89% in the second cycle, and up to 99% after the tenth cycle. Additionally, as shown in FIG. 2C, the retention capacity at 100 cycles was 266 mA hg−1, which was shown higher than that of the FeOOH polymorph in SIB (FIG. 9). In addition, it could be confirmed that FAHP exhibits excellent characteristics by rate (FIG. 8D).

### 8. Evaluation of In Situ and Ex Situ Properties According to Structure

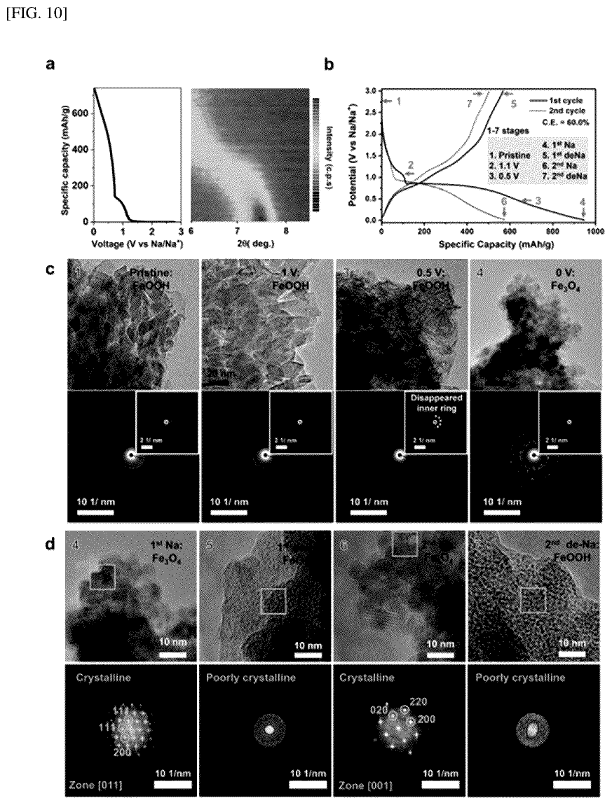

FIG. 10 shows results of confirming the charge/discharge process conversion mechanism of FAHP according to this embodiment. In FIG. 10, FIG. 10A is an in situ XRPD color map obtained from a galvanostatic profile, and shows the intercalation of Na ions and the conversion of the pristine iron oxide phase. FIG. 10B is galvanostatic charge/discharge profiles of the FAHP/Na cell at a current density of 20 mA g⁻¹. TEM ex situ data points were indicated by arrows with respect to corresponding numbers (1 to 7). FIG. 10C is HR-TEM images for steps 1 to 4 of the initial discharge process and the SAED patterns according thereto, and FIG. 10D is HR-TEM images for steps 4 to 7 of the complete charge/discharge process up to the second cycle and the FFT patterns according thereto.

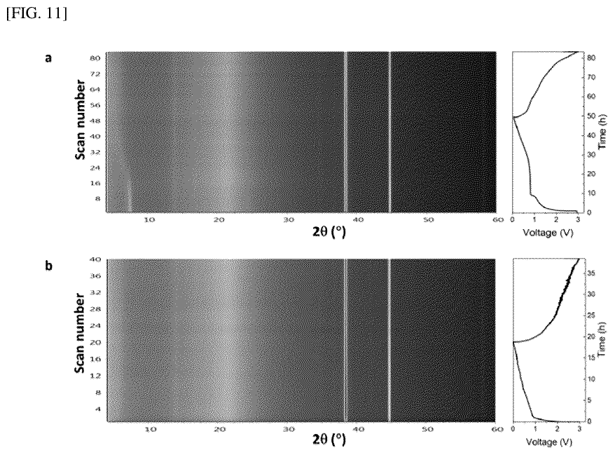

FIG. 11 shows results of 2D in situ XRD analysis of FAHP. In FIG. 11, FIG. 11A is an analysis result during the first cycle of FAHP in the potential range of 0.01 to 3.0 v at a current density of 20 mA g⁻¹, and FIG. 11B is an analysis result after performing 10 cycles. A single XRD pattern was maintained for 1 hour or more in the process of performing the cycle. Color bar indicates peak intensity of XRD pattern.

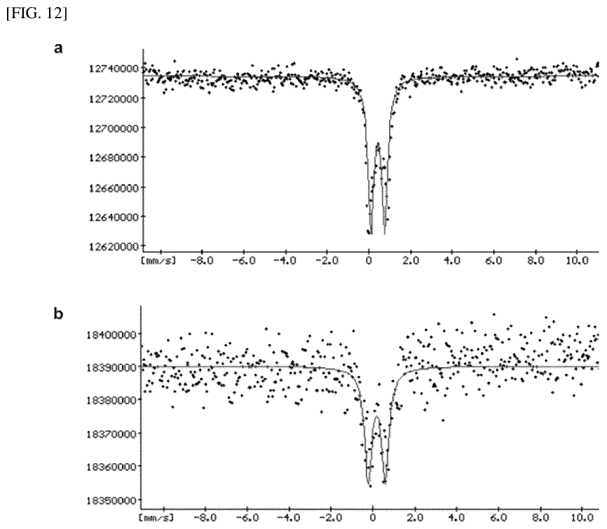

FIG. 12 shows Mossbauer spectra of FAHP. FIG. 12A indicates isomer shift (electrode) of 0.41 mm s⁻¹ and quadrupole splitting of 0.65 mm s⁻¹ (γ-FeOOH), and FIG. 12B indicated the first sodiated FAHP electrode having isomer shift of 0.3 mm s⁻¹ and quadrupole splitting of 0.8 mm s⁻¹ (Fe₃O₄). The Mossbauer spectrum of the sample was fit to a doublet.

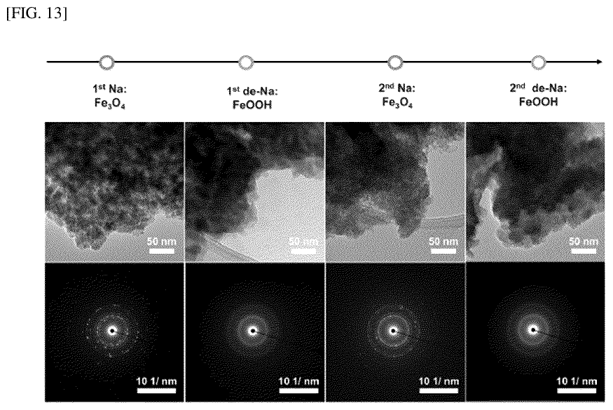

FIG. 13 shows phase conversions of FAHP according to the conversion reaction. These are ex situ bright-field TEM images and SAED patterns of the FAHP electrode after performing the first and second charge/discharge cycles. Clear ring patterns at D=2.83, 2.53, 2.51, 1.42, 1.20, and 1.01 nm were secured from the sodiated samples, meaning the presence of crystals of the Fe3O4 phase. The diffused ring patterns at d=2.15 and 1.52 nm mean the presence of a low-crystalline FeOOH phase.

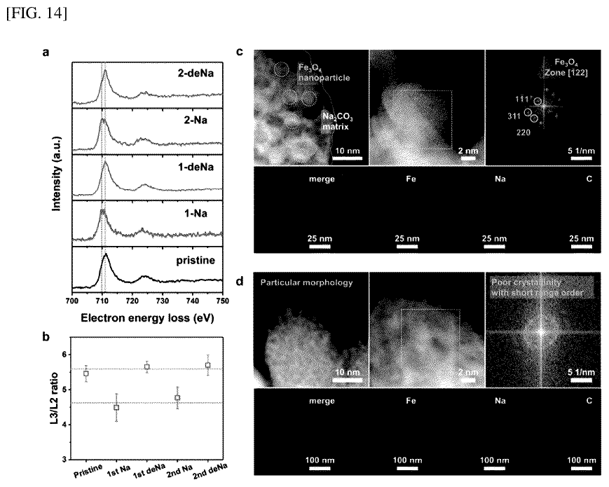

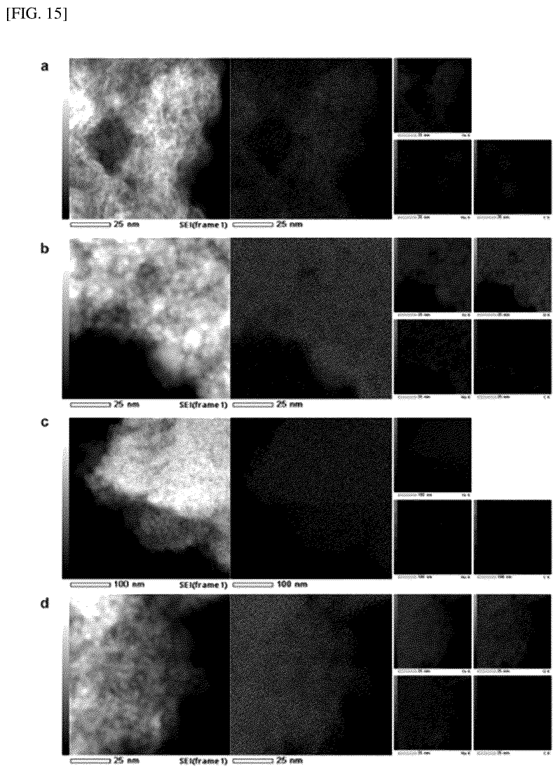

FIG. 14 shows results of confirming microstructural changes that occur in the charge/discharge process of FAHP according to this embodiment. In FIG. 14, FIG. 14A is the EEL spectra at the Fe L_{2,3} edge before and after the charge/discharge cycle, and FIG. 14B is the ratios between the L₃ and L₂ peak intensities in the EEL spectra. In FIGS. 14A and 14B, the reversible peak shift indicated by the gray dotted line was observed during the charge/discharge cycle, and it means that it was in the Fe3+ state in FOOH during desodiation, and the partially reduced states (Fe3+ and Fe2+) are formed in Fe3O4 phase during sodiation. FIG. 14C is HAADF-STEM images, and FIG. 14D is FFT patterns and elemental map recorded according to the initial discharge and charge process. The respective elements in FIGS. 14C and 14D were indicated by unique colors. Fe is red, Na is green, O is yellow, and C is blue.

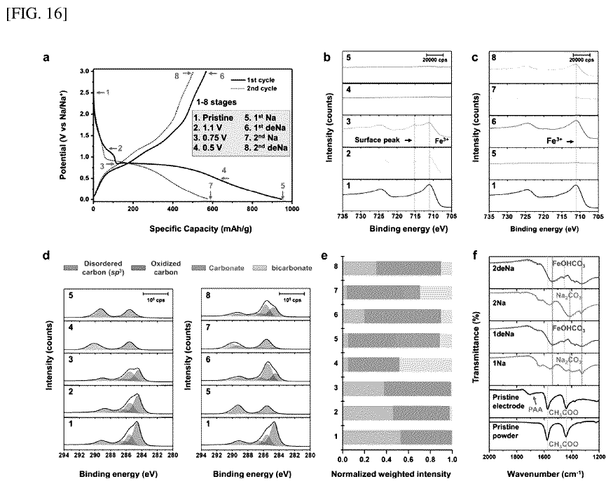

FIG. 15 shows results of elemental analysis performed in the FAHP conversion reaction. It is ex situ EDS elemental maps, and confirmed the cycled electrodes at different steps. FIG. 15A means 0.5V discharge, FIG. 15B means initial full discharge, FIG. 15C means initial full charge, and FIG. 15D means second full discharge, respectively. The respective atomic elements were indicated by Fe (red), Na (green), O (yellow), and C (blue).

To confirm the structural changes in the charge/discharge process, in situ XRPD and ex situ TEM were performed. In the in situ XRPD pattern, only the main peak could be distinguished even in the Princeton state (FIG. 10A). During discharge to 1 V, the main peak at 7.5° was maintained, but continued to shift to lower angles. This means that the interlayer spacing of FAHP is expanded, and accordingly, the interlayer insertion of Na⁺ is facilitated.

In the process of further discharging to a voltage lower than 1 V, no peak was detected, and this meant that the structure was destroyed and ultrafine particles were formed in the conversion reaction process. To confirm the ultrafine particles, ex situ TEM was performed (FIGS. 10B to 10D). Referring to the constant current profiles and high-resolution TEM (HR-TEM) images for steps 1 to 7, electrodes of different potentials were prepared in the charge/discharge process (FIG. 10B).

First, to analyze the initial discharge process, the reaction was started at an equilibrium potential of 2.5 V versus Na/Na⁺ (FIG. 10C). For electrodes discharged at potentials exceeding 1 V (step 2), a low capacity (up to 11%) was recorded before reaching the activation overpotential while maintaining the layered structure of FAHP. For such electrodes, there are not significant changes in the morphology and SAED pattern (FIGS. 10C1 and 10C2), which was consistent with the XRPD results, meaning that the intercalation of Na⁺ dominates this step (FIG. 10A and FIG. 11). Upon continuously performing discharge up to 0.5 V (step 3), it could be confirmed that each individual layer of the nanoplatelet randomly collapsed into scattered fragments, and this is consistent with the fact that internal rings derived from the basal spacing of the SAED pattern without Bragg reflection in the in situ XRPD data disappear (FIG. 10C3).

After fully discharging it to 0 V (step 4), the FAHP phase was converted into Fe₃O₄ nanoparticles with a size smaller than 10 nm, which were confirmed as ring patterns at d=4.85, 2.96, 2.53, 2.10, 1.72, 1.48, and 1.28 nm, respectively, due to (111), (220), (311), (400), (422), (440), and (533) planes which are the inverse spinel structures of Fe₃O₄ in the SAED pattern (FIG. 10C4).

The FFT pattern shows a single crystal spot pattern due to the inverse spinel crystal structure shown along the [011] zone axis, and this means that nanocrystalline Fe₃O₄ was formed in the initial discharge process (FIG. 10D4). This means that such a phase consists of pure Fe₃O₄ that has not undergone Na intercalation.

Similar to previous reports, the in situ XRPD pattern did not show small-sized Fe₃O₄ crystals generated in the discharge process. The Mossbauer spectra of the Princeton FAHP and the initial sodium-charged FAHP electrode appeared similar to the spectra of lepidocrocite and superparamagnetic Fe₃O₄, each of which had a size of several nanometers (FIG. 12). In other words, it means that, due to intercalation of Na⁺ ions, iron in the Fe state is reduced, and FeOOH is changed into Fe₃O₄ nanoparticles.

In the subsequent charge/discharge cycle, the layered structure of FAHP was not recovered by the charging process (FIG. 10D). Desodiation (step 5) produced a noncrystalline FFT pattern (FIG. 10D5). In the SAED pattern, the diffraction ring patterns diffused at d=0.15 and 0.26 nm mean low crystallinity of FeOOH, which was consistent with the diffraction patterns shown in the FeOOH synthesis process (FIG. 13). In the second cycle, sodiation (step 6) regenerated Fe₃O₄, and subsequent desodiation (step 7) produced low crystalline FeOOH so that the reversible conversion could be confirmed to be performed between crystalline Fe₃O₄ and low crystalline FeOOH (FIGS. 10D6 and 10D7).

The occurrence of such a reversible conversion reaction could be confirmed in the electron energy-loss (EEL) spectra. The chemical shift in the EEL spectra and the changes in the L₃/L₂ intensity ratio in the charge/discharge process were exhibited reversibly (FIGS. 14A and 14B). In the charge/discharge cycle process, the peak position of the Fe2p L₃ edge repeatedly chemically shifted between 711.3 eV (FeOOH) and 710.1 eV (Fe₃O₄), which means that Fe of the oxidation state changes reversibly in FeOOH (Fe³⁺) and Fe₃O₄ (mixed state of Fe³⁺ and Fe²⁺) (FIG. 14A). Low values of L₃/L₂ were exhibited by the sodiated electrode in the first and second cycles, which means that a state of Fe is a slightly reduced oxidation state after the discharge process (FIG. 14B).

The electrochemical reaction mechanism for the conventional FeOOH anode is by the reversible conversion of FeOOH↔Fe or FeO↔Fe. On the other hand, the FAHP anode according to this embodiment is characterized in that FeOOH is not reduced to metallic Fe but is converted to partially reduced Fe₃O₄. At this time, the partial reduction of Fe³⁺ (FAHP) to Fe²⁺ (Fe₃O₄) shows a capacity significantly lower than that determined in electrochemical tests.

In other words, it could be confirmed that reactions other than that contributing to reversible and irreversible sodiation exist.

FIGS. 14C and 14D, and FIG. 15 show elemental mapping images according to HAADF-STEM and energy dispersive X-ray spectroscopy (EDS) after proceeding with the charge/discharge process.

After performing an initial discharge process, Fe₃O₄ nanoparticles smaller than 10 nm were individually encapsulated in an amorphous matrix and aggregated to have different crystallographic orientations. In the EDS elemental mapping images, Na was absent in the Fe₃O₄ nanoparticles, and Na and C were shown to be rich in the matrix (FIG. 14C). In the bright-field HR-TEM images, an amorphous layer could be confirmed in the Fe₃O₄ nanoparticles (FIGS. 10D4 and 10D6).

After the initial discharge, it could be confirmed that the FeOOH phase in the desodiated electrode had poor crystallinity, and a particle morphology similar in size to the Fe₃O₄ nanoparticles observed in the sodiated electrode was present (FIG. 14D). The change in intensity (Z-contrast) means that the organic moiety and FeOOH nanoparticles form a dense complex state. On the other hand, the boundary between FeOOH and Na appeared vague in the elemental map of the sodiated electrode, which means that Na was decomposed in the charging process. This means that the matrix associated with Na salts (analogous to carbonates) is one of the main sources of electrochemical capacity and only partially contributes to the electrochemical capacity by partial reduction of Fe³⁺.

### 9. Surface Reaction Analysis

FIG. 16 shows results of analyzing the surface reaction of the FAHP anode in an embodiment of the present disclosure. In FIG. 16, FIG. 16A is XP and FT-IR spectra, wherein ex situ data points were indicated by each arrow and corresponding numbers (1 to 8) in the galvanostatic charge/discharge profile of a FAHP/Na cell cycled at a current density of 20 mA g⁻¹. The Fe2p XP spectra were shown as (FIG. 16B) steps 1 to 5 that are the initial discharge process, and (FIG. 16C) steps 5 to 8 in the first and second charge/discharge cycles. The positions of the Fe³⁺ surface and Fe³⁺ lattice were indicated by gray dotted lines in FIGS. 16B and 16C. FIG. 16D is C1s XP spectra of steps 1 to 8 in the charge/discharge cycle. The deconvoluted peaks were indicated by bicarbonate (purple), carbonate (orange), oxidized carbon (green), and sp³C, respectively. FIG. 16E schematically shows surface compositions of the samples from the C1s XP spectra. FIG. 16F is FT-IR spectra for the Prinstine FAHP, the Prinstine electrode, and the electrode that completed the charge/discharge process until the second cycle. In FIG. 16F, the positions of the vibrational peaks of CH₃COO, Na₂CO₃, and FeOHCO₃ (surface-bound HCO₃₋) were indicated by gray, orange and purple solid lines, respectively.

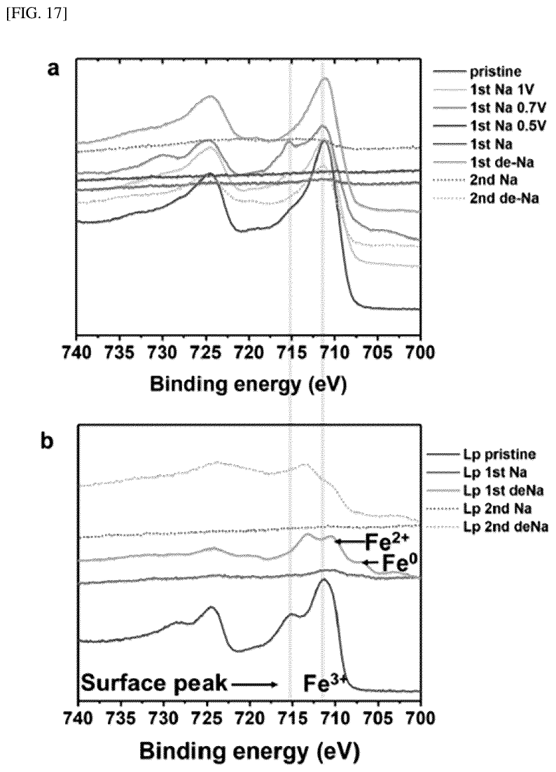

FIG. 17 is conversion reaction graphs obtained from Fe2p XP. FIG. 17 shows the Fe2p XP profiles for FAHP (FIG. 17A) and lepidocrocite (FIG. 17B), respectively.

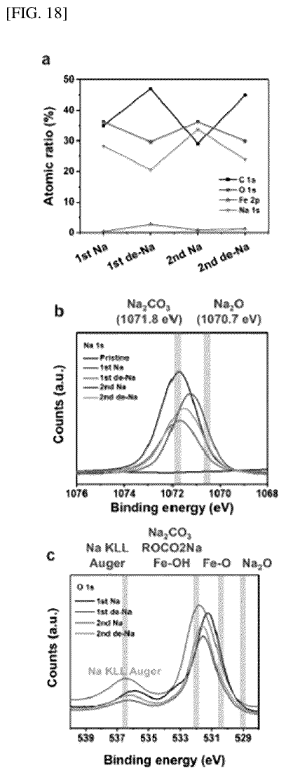

FIG. 18 shows results of surface analysis. FIG. 18A is XPS results in the charge/discharge cycle, and FIG. 18B is Na 1s XPS profile during the charge/discharge cycle. The peak at 1,071.8 eV corresponds to Na₂CO₃, and appeared at a higher intensity than Na₂O (1,070.7 eV). FIG. 18C is the O 1s XPS profile confirmed in the charge/discharge process, and it could be confirmed that Na₂O did not significantly affect the O 1s profile.

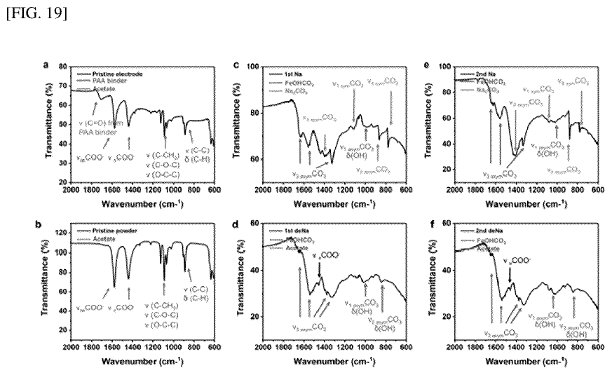

FIG. 19 showed FT-IR spectra. FIGS. 19A to 19F are FT-IR results for Prinstine FAHP, Prinstine electrode, initially sodiated electrode, initially desodiated electrode, secondly sodiated electrode, and secondly desodiated electrode, respectively. The vibrational modes of each spectrum were indicated in gray (acetate), green (PAA binder), purple (HCO³⁻ coordinated to the FeOOH surface), and orange (Na₂CO₃).

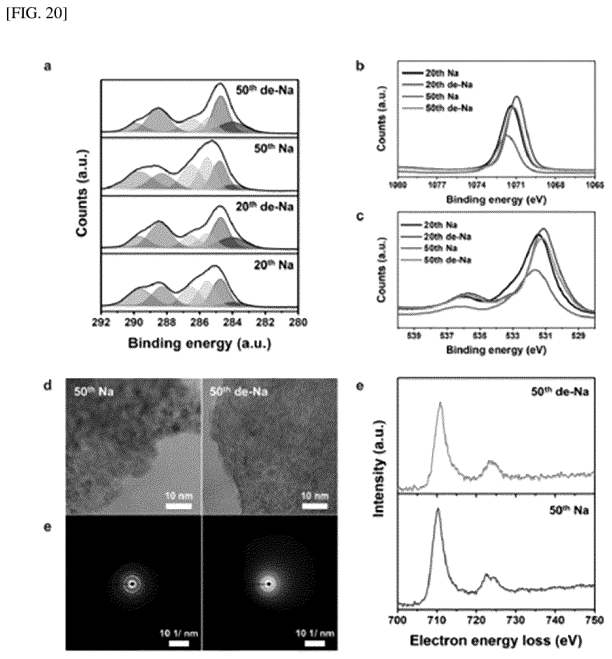

FIG. 20 shows results of analyzing the conversion reaction at 20 cycles and 50 cycles. FIG. 20A exhibited C1s XP spectra for full discharge and charge at 20 and 50 cycles. In FIG. 20A, the deconvoluted peaks were indicated as Na₂CO₃ (orange), COO— (green), CO—Fe (sky blue), sp³ C (blue), and sp² C (grey), and were presented in order of increasing binding energy (BE). Na₂CO₃ remained in all samples as it formed and decomposed reversibly, and in particular, Na₂CO₃ remained at the predominant proportion in the discharged sample. Na 1s spectra (FIG. 20B) and O 1s XP spectra (FIG. 20C) at full discharge and charge steps at 20 and 50 cycles were indicated. FIG. 20D is HR-TEM images at 50 cycles, FIG. 20E is SAED patterns at 50 cycles, and FIG. 20F is EEL spectra at 50 cycles. Even after performing charging and discharging for 50 cycles, the conversion reaction from Fe₃O₄ to FeOOH was performed well. In particular, Na₂CO₃ was partially stabilized after 20 and 50 cycles, but formation and decomposition of Na₂CO₃ were repeatedly performed. Additionally, successive cycles reduced the size of Fe₃O₄ crystals to a slightly finer size (<5 nm).

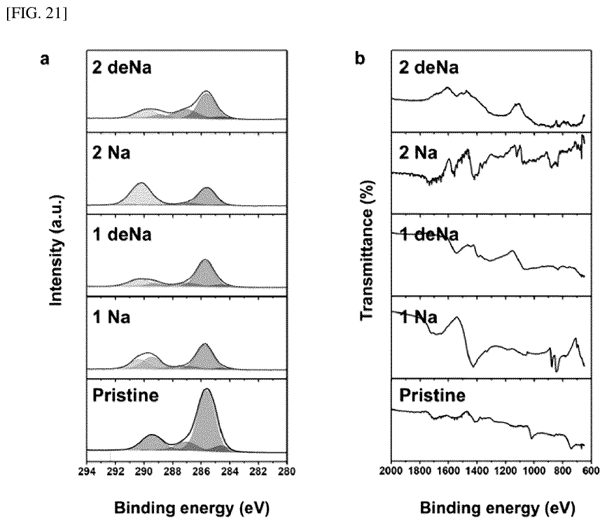

FIG. 21 shows results of analyzing the surface reaction of lepidocrocite. FIG. 21 exhibited C1s XPS profiles (FIG. 21A) and FT-IR spectra (FIG. 21B) of lepidocrocite in the charge/discharge process. The deconvolved peaks of the C1s XP spectra were indicated as bicarbonate (purple), carbonate (orange), carbon oxide (green), and sp³ C (blue).

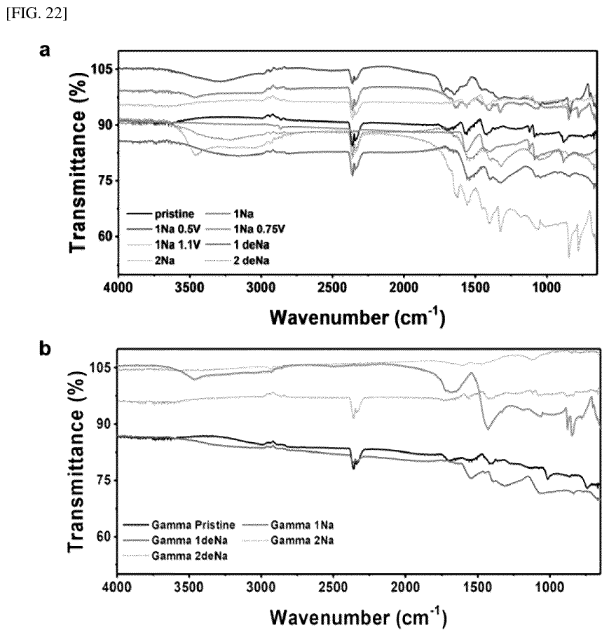

FIG. 22 shows results of analyzing the surface reaction of FAHP and lepidocrocite. FIG. 22 shows results of recording FT-IR in each charge/discharge process for FAHP (FIG. 22A) and lepidocrocite (FIG. 22B).

Since carbon exists only in acetate moieties in FAHP, surface reactions occur mainly only in the acetate moieties. In order to confirm the reaction pathway, XPS and FT-IR spectroscopy were confirmed on the electrodes prepared in different steps from steps 1 to 8 (FIG. 16). Additionally, in order to confirm the surface reaction of FAHP and the expanded structure of lepidocrocite, it was compared with the surface response of lepidocrocite lacking interlayer-inserted acetate molecules.

The peak at 712 eV in the Fe2p XP spectra did not shift until 0.75 V in the initial discharge process (steps 1 to 3) (FIG. 16B). This means that the local structure of Fe³⁺ was roughly maintained, but Na ions were inserted into the interlayer space. The intensity of the surface peak at 715 eV gradually increased during the steps 1 to 3, indicating a maximum value in the XPS profile similar to that of Prinstine lepidocrocite. As with the TEM results described above, it could be confirmed that the acetate moieties were cleaved from FAHP at a potential of less than 1 V, and as a result, FAHP had a lepidocrocite-type surface state.

Na generated on the surface during the steps 4 and 5 interfered with the detection of the XPS signal due to the limited detection depth of XPS (˜5 nm), and accordingly the intensity of the Fe signal was greatly reduced. That is, over a flat voltage plateau of up to 0.5 V (step 4), the layered structure of FAHP collapsed and was simultaneously created on the surface. On the other hand, during the step 6 (complete desodiation), the Fe2p XPS signal reappeared. This step restores to the original Fe³⁺, and is due to the decomposition of Na and the formation of low-crystalline FeOOH. Such a phenomenon was reproduced in the second charge/discharge cycle. In contrast, the lepidocrocite system did not recover to the Fe³⁺ state upon desodiation, producing metallic Fe⁰ and Fe³⁺ states (FIG. 17).

The C1s XP spectra (FIG. 16D) and surface compositions (FIG. 16E) obtained by deconvolution of the C1s spectra indicate the formation and decomposition of Na in the charge/discharge cycle process. In the steps of 1 to 3 of the C1s XP spectra, the peak intensity at 284.5 eV due to sp³ carbon gradually decreased, and the carbon oxide (C—O) signal increased at 285.5 eV and 286.5 eV. The sp³ carbon originated from the acetate moieties inserted into FAHP. In other words, the C1s XPS profile of lepidocrocite did not indicate a sp³ carbon peak. Therefore, the reduction of sp indicates desorption of the acetate moieties from FAHP (especially the step 3).

In the step 4, where Na dominates the surface, an intense peak at 290.1 eV originating from bicarbonate (HCO³⁻) appeared. In the step 5 (complete sodiation), bicarbonate was converted to carbonate to produce a more stable compound together with Na-sodium carbonate (Na₂CO₃). As in the Na1s and O1s XP spectra of the sodiated electrode, Na₂CO₃ was present in greater amounts than Na₂O, which meant a solid-electrolyte interface (SEI) created by the iron oxide system (FIG. 18).

In the charging process of the step 6, the intensity of the carbonate peak at 289.2 eV decreased rapidly, but it could be confirmed that the bicarbonate peak at 290.1 eV and the carbon oxide and sp³ carbon peaks related to acetate reappeared. This implies two reaction pathways for the decomposition of Na₂CO₃, (i) binding of bicarbonate to the surface of FeOOH to form FeOHCO₃ and (ii) reconversion to acetate.

The FT-IR spectra in the charge/discharge process indicate the reversible formation and decomposition of Na₂CO₃ (FIGS. 16F and 19). The FT-IR spectra of Prinstine FAHP and electrode mean that acetate inserted into FAHP is the main component of the electrode surface. In the FT-IR spectra of the sodiated electrode produced in the first and second cycles, the prominent vibrational peaks in the FT-IR spectra were indicated by Na₂CO₃ and NaHCO₃. On the other hand, in the spectra of the desodiated electrode produced in the first and second cycle processes, the peak intensity corresponding to the carbonate component was greatly reduced.

The FT-IR spectra mainly consist of peaks attributed to acetate and bicarbonate moieties complexed to the FeOOH surface. Additionally, the change in peak position in the charge/discharge process was shown to be reversible in both XP and FT-IR spectra. The reversible formation and decomposition of Na₂CO₃ accompanying the FeOOH—Fe₃O₄ conversion reaction exhibited a Coulombic efficiency of approximately 100% at 20 and 50 cycles, respectively (FIG. 20). In the case of lepidocrocite without acetate intercalation, the reversible behaviors of the sp³ carbon peaks did not appear in the C1s spectra, and the peak intensities in the FT-IR spectra for Na were shown to be significantly lower than that of FAHP (FIGS. 21 and 22). Na₂CO₃ is an SEI compound commonly detected in SIB cathodes, but it is reported to have lower reversibility than the results of this embodiment.

Embodiments according to the present disclosure confirmed that an extended lepidocrocite-type nanoplatelet structure in which organic molecules are interlayer-inserted can be used as a SIB anode active material. The insertion of Na ions between the extended interlayer spaces of FAHP can a uniform conversion reaction to be enabled over the entire surface of a single FeOOH layer so that a high specific surface area may be induced. FAHP is due to a new conversion reaction similar to biological reactions, in which the redox reactions of inorganic and organic components cause a synergistic effect so that electrochemical capacity and stability may be improved.

In addition, it could be confirmed that in the anode active material for a sodium secondary battery according to this embodiment, the bicarbonate and carbonate moieties generated by the redox reaction became a stable reversible host for Na ions. The conversion reaction according to this embodiment may overcome the limitations of low retention stability and capacity of the existing FeOOH system.

Those skilled in the art to which the present disclosure pertains will understand that the present disclosure can be implemented in other specific forms without changing its technical idea or essential features. Therefore, the embodiments described above should be understood in all respects as illustrative and not restrictive. The scope of the present disclosure is indicated by the scope of the claims described below rather than the detailed description above, and all changes or modified forms derived from the meaning and scope of the claims and their equivalent concepts must be interpreted to be included in the scope of the present disclosure.

What is claimed is:

1. An anode active material for a sodium secondary battery, which has a layered crystal structure and is formed of nanoplatelets containing iron oxide having organic anions, and in which the nanoplatelets are provided in plural numbers and formed in a stacking structure spaced apart at a first interval.

2. The anode active material for a sodium secondary battery of claim 1, wherein the iron oxide includes FeOOH or Fe₃O₄, and the organic anions include an acetate (CHCOO—)-based compound.

3. The anode active material for a sodium secondary battery of claim 2, wherein the organic anions include an acetate group, and the acetate group is connected to the iron oxide by bidentate bridging.

4. The anode active material for a sodium secondary battery of claim 1, wherein the nanoplatelets include a lepidocrocite-type structure.

5. The anode active material for a sodium secondary battery of claim 1, wherein the nanoplatelets are 1.8 to 2 times the lattice spacing of orthorhombic lepidocrocite.

6. The anode active material for a sodium secondary battery of claim 1, wherein the layered crystal structure has lattice constants of a=3.035±0.003 Å, b=22.86±0.02 Å, and c=3.8120±0.001 Å.

7. The anode active material for a sodium secondary battery of claim 1, wherein the first spacing is 1.14 nm to 1.29 nm as a spacing between (101) planes.

8. The anode active material for a sodium secondary battery of claim 1, wherein FeOOH nanoparticles are reversibly converted into Fe₃O₄ nanoparticles in the charge/discharge process, the FeOOH nanoparticles and Fe₃O₄ nanoparticles each have an average diameter of 10 nm or less, and the crystallinity of the Fe₃O₄ nanoparticles is higher than that of the FeOOH nanoparticles.

9. The anode active material for a sodium secondary battery of claim 1, wherein the nanoplatelets have a disk-shaped morphology, and the nanoplatelets have a width of 27±5 nm and an axial thickness of 19±6 nm.

10. The anode active material for a sodium secondary battery of claim 1, wherein the anode active material for a sodium secondary battery includes a repeatedly stacked nanoplatelet structure and perform intercalation of sodium ions and a biotic-reaction-type conversion reaction.

11. The anode active material for a sodium secondary battery of claim 10, wherein the anode active material includes an iron oxide having an acetate group, the iron oxide is FeOOH nanoparticles or Fe₃O₄ nanoparticles, the anode active material is reduced from FeOOH nanoparticles to Fe₃O₄ nanoparticles during charging, the acetate group is oxidized, and bicarbonate is formed by the oxidation of the acetate group so that it acts as a host for storing sodium ions.

12. The anode active material for a sodium secondary battery of claim 11, wherein the acetate group is oxidized to produce bicarbonate ions (HCO³⁻), and the bicarbonate ions act as a host for storing sodium ions to produce any one or more of sodium hydrogen carbonate (NaHCO₃) and sodium carbonate (Na₂CO₃).

13. A sodium secondary battery comprising:
an anode containing the anode active material for a sodium secondary battery according to claim 1; and
a cathode containing sodium,
wherein the anode contains Na₂CO₃ or Na₂O in the surface thereof, and Na₂CO₃ is provided in a larger amount than Na₂O.

14. The sodium secondary battery of claim 13, wherein the anode active material includes iron oxide having an acetate group, the iron oxide is FeOOH nanoparticles or Fe₃O₄ nanoparticles, the anode active material is reduced from FeOOH nanoparticles to Fe₃O₄ nanoparticles during charging, the acetate group is oxidized to produce bicarbonate ions (HCO³⁻), and the bicarbonate ions act as a host for storing sodium ions to produce any one or more of sodium hydrogen carbonate (NaHCO₃) and sodium carbonate (Na₂CO₃).
